(19) United States
(12) Patent Application Publication
(10) Pub. No.: US 2022/0266700 A1
(43) Pub. Date: Aug. 25, 2022

(54) DAMPING CONTROL DEVICE AND DAMPING CONTROL METHOD

(71) Applicant: Nidec Corporation, Kyoto (JP)

(72) Inventors: Linfeng LAN, Kawasaki-shi (JP); Tomohiro FUKUMURA, Kyoto (JP); Tomonari MORI, Kawasaki-shi (JP)

(21) Appl. No.: 17/632,833

(22) PCT Filed: Jul. 21, 2020
(86) PCT No.: PCT/JP2020/028275

§ 371 Date: Feb. 4, 2022

(30) Foreign Application Priority Data
Aug. 15, 2019 (JP) 2019-149086

(51) Int. Cl. B60L 15/20; H02P 23/04

(52) U.S. Cl. CPC B60L 15/20; H02P 23/04; B60L 2240/421; B60L 2240/647; B60L 2240/12; B60L 2240/461

(57) ABSTRACT

A torque control of an in-vehicle motor is performed in consideration of a slip prevention control. Filtering processing is performed by a first filter processor on a high-order torque command value from a high-order device, and filtering processing is performed by a second filter processor on an angular velocity detected by an angular velocity detector. A driving torque command value to drive an electric motor is calculated based on filtering processing results. Each of the filter processors changes a time constant of the filtering processing according to a road surface friction coefficient as disturbance information.

### CROSS-REFERENCE TO RELATED APPLICATIONS

This is a U.S. national stage of application No. PCT/JP2020/028275, filed on Jul. 21, 2020, and with priority under 35 U.S.C. § 119(a) and 35 U.S.C. § 365(b) being claimed from Japanese Patent Application No. 2019-149086, filed on Aug. 15, 2019, the entire disclosures of which are hereby incorporated herein by reference.

### 1. FIELD OF THE INVENTION

The present disclosure relates to a damping control device and a damping control method to suppress, prevent, or minimize vibration caused by a driving motor of a vehicle.

### 2. BACKGROUND

In a driving electric motor in an electric vehicle, a hybrid vehicle, or the like, a drive shaft is a low rigidity load, and thus, torque generated by the electric motor is transmitted while the shaft is twisted. Therefore, a motor drive system (powertrain) becomes a resonance system having a low resonance frequency, and it is a conventional problem to satisfactorily damp the generated vibration.

Conventionally, a fact that a resonance point of a wheel drive system from an electric motor to a wheel changes with a change in a road surface friction coefficient (road surface μ) is focused, and a damping control device is known that reduces torsional vibration of a vehicle drive system based on an estimated road surface friction coefficient.

There is known a technique for correcting a control parameter in performing damping control for reducing torsional vibration of a vehicle drive system based on the estimated road surface friction coefficient in view of a problem that a conventional damping control technique cannot obtain a sufficient damping control effect and hunting occurs since a difference occurs between a resonance point on an actual road surface and a resonance point in the damping control when a vehicle travels on a low friction coefficient road surface (low μ road surface) using a control parameter corresponding to a high friction coefficient road surface (high μ road surface).

Regarding the prevention of sideslip of wheels, for example, a conventional driving force control device of a vehicle controls a driving force in order to achieve both turning performance during turning travel and vehicle stabilization such as sideslip prevention. Conventionally, as illustrated in FIG. 7, the “driving force correction amount of a sideslip prevention control” is from zero to negative when a sideslip prevention device is in operation. That is, a command torque value is controlled to be lowered in order to prevent the sideslip of wheels (slip prevention).

According to the conventional damping control device, a damping control effect can be obtained in a case where the road surface friction coefficient changes, but control for the slip prevention is not considered. On the other hand, there is a conventionally known vehicle control system in which, when a change is made from an asphalt having a large road surface friction coefficient to a frozen road having a small road surface friction coefficient, as a slip prevention control, a torque command is lowered from a vehicle control unit VCU to a motor control unit MCU in consideration of a road surface condition. However, in the conventional control of only lowering the command torque value, effective damping control such as slip prevention cannot be performed.

On the other hand, as a damping control technique for suppressing a resonance vibration, a technique for reducing the resonance vibration by performing a feedback control (FB) and a feedforward control (FF) at the time of performing a torque control is generally known. However, such a damping control by the FB and the FF causes a time delay due to filter processing. As a result, when the slip prevention control is performed using the conventional damping control technique, there arises a problem that the responsiveness of the slip prevention control decreases, and the slip prevention control does not operate properly.

### SUMMARY

Example embodiments of the present disclosure are able to solve the above-described problem. An example embodiment of the present disclosure provides a damping control device which suppresses, prevents, or minimizes vibration of a vehicle. The example embodiment provides a device which includes an angular velocity detector to detect an angular velocity of a driving motor of a vehicle, a first filter processor to perform filtering processing on a high-order torque command value transmitted from a high-order device, a second filter processor to perform filtering processing on the angular velocity detected by the angular velocity detector, and a calculator to calculate a driving torque command value to drive the motor based on a filtering processing result by the first filter processor and a filtering processing result by the second filter processor. A predetermined filter control according to a change in the high-order torque command value is performed by inputting predetermined information obtained from the vehicle to the first filter processor, or the first filter processor and the second filter processor.

Another example embodiment of the present disclosure is a vehicle including the damping control device according to the above-described example embodiment of the present disclosure.

Still another example embodiment of the present disclosure is a damping control method which suppresses, prevents, or minimizes vibration of a vehicle. The method includes detecting an angular velocity of a driving motor of the vehicle, performing first filtering processing on a high-order torque command value transmitted from a high-order device, performing second filtering processing on the detected angular velocity, and calculating a driving torque command value to drive the motor based on a filtering processing result obtained by the first filtering processing and a filtering processing result obtained by the second filtering processing. In the first filtering processing, or in the first filtering processing and the second filtering processing, a predetermined filter control according to a change in the high-order torque command value is performed by inputting disturbance information obtained from the vehicle or vehicle information, or the disturbance information and the vehicle information.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a block diagram illustrating an overall configuration of a vehicle drive apparatus using a damping control device according to an example embodiment of the present disclosure.

FIG. 2 is a flowchart illustrating a time constant adjustment processing procedure and a filtering processing procedure in a filter processor of a damping control device according to an example embodiment of the present disclosure.

FIG. 3 is a diagram illustrating an example of an adjustment characteristic of a time constant of a filter with respect to a change in a road surface friction coefficient.

FIG. 4 is a diagram illustrating an example of the change in the road surface friction coefficient.

FIG. 5 is a diagram illustrating a simulation result of a time delay of a torque response with respect to the presence or absence of time constant adjustment of a filter.

FIG. 6 is a diagram illustrating a simulation result of a slip rate of a vehicle with respect to the presence or absence of the time constant adjustment of the filter.

FIG. 7 is a time chart illustrating a change in driving force during operation of a conventional sideslip prevention device.

### DETAILED DESCRIPTION

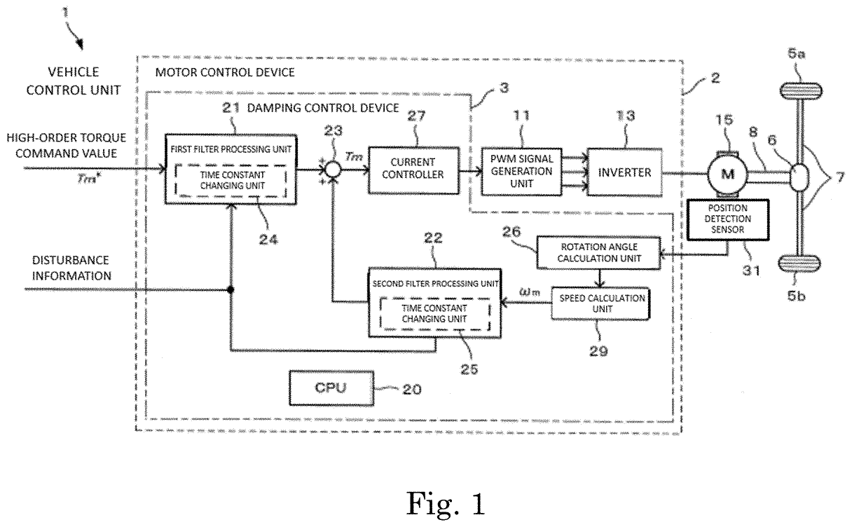

Example embodiments of the present disclosure will be described in detail below with reference to the accompanying drawings. FIG. 1 is a block diagram illustrating an overall configuration of a vehicle drive apparatus using a vibration suppression control device (also referred to as a damping control device) according to an example embodiment of the present disclosure. A vehicle drive apparatus VCU (Vehicle Control Unit) 1 in FIG. 1 is a drive apparatus of a vehicle using an electric motor 15 as a driving source, and includes a motor control device MCU (Motor Control Unit) 2 and a damping control device 3.

As will be described later, the motor control device 2 includes a pulse width modulation (PWM) signal generation unit 11 which generates a motor drive signal (PWM signal) according to the current control signal generated by the damping control device 3 which suppresses vibration of the vehicle, and an inverter 13 which receives the motor drive signal from the PWM signal generation unit 11 and functions as an FET drive circuit (motor drive circuit).

The inverter 13 is an FET bridge circuit including a plurality of semiconductor switching elements, and is supplied with power for driving the motor from an external battery (not illustrated). The motor drive signal is a signal indicating a duty ratio of the PWM signal, and is an ON/OFF control signal of a semiconductor switching element such as a metal-oxide semiconductor field-effect transistor (MOSFET) or an insulated gate bipolar transistor (IGBT) configuring the inverter 13.

A predetermined drive current is supplied from the inverter 13 to the electric motor 15 to drive the electric motor 15. More specifically, the inverter 13 sends a three-phase alternating current of a U phase, a V phase, and a W phase to the electric motor 15 according to the motor drive signal. The torque generated by the electric motor 15 driven by the current is transmitted to a drive shaft 8, so that a pair of wheels 5a and 5b are driven via a differential gear 6 and an axle 7. The electric motor 15 is, for example, a three-phase brushless DC motor.

Next, the damping control device according to this example embodiment will be described. As illustrated in FIG. 1, the damping control device 3 receives a torque command from the vehicle drive apparatus (VCU) 1, which is a high-order device, and a road surface friction coefficient TF as disturbance information, and adjusts a time constant of a filter, thereby suppressing vibration of the vehicle (the slip prevention control of the vehicle).

A controlling section (CPU) 20 includes, for example, a microprocessor that controls the entire damping control device 3. Incidentally, the road surface friction coefficient is detected on the vehicle side without the calculation of the motor control device, whereby a processing load in the motor control device (damping control device) can be reduced.

The damping control device 3 includes a first filter processor 21 which performs filtering processing on a high-order torque command value Tm* transmitted from the vehicle drive apparatus (VCU) 1 and a second filter processor 22 which performs filtering processing on a rotational angular velocity ωₘ of the driving motor (electric motor 15) of the vehicle. In the damping control device 3, the first filter processor 21 and the second filter processor 22 suppress the resonance vibration of the vehicle power train (slip prevention control).

A position detection sensor 31 is disposed near the electric motor 15. A rotation angle calculation unit 26 calculates the rotation angle of the electric motor 15 based on the magnetic field detection result of the position detection sensor 31. A speed calculation unit 29 calculates the rotational angular velocity ωₘ of the electric motor 15 based on the output from the rotation angle calculation unit 26. By using, for example, a Hall element as the position detection sensor 31, the rotational position of the motor can be detected with a configuration which is less expensive than a resolver, an encoder, and the like.

The first filter processor 21 is a notch filter or a low-pass filter (LPF) having a characteristic expressed by following Equation (1). The notch filter has a characteristic of attenuating a signal of a specific wavelength band to a low level and transmitting other signals (having a narrow stop frequency range). In Equation (1), s is a Laplace operator, and T is a time constant. Further, the time constant T is a function of the road surface friction coefficient TF (T=f(TF)).

$$[ Equation 1 ]$$

$$G 1 = 1 - \frac{{T}_{2} s}{( 1 + {T}_{1} s ) ( 1 + {T}_{3} s )} \qquad ( 1 )$$

In the first filter processor 21, a time constant changer 24 adjusts the time constant of the filter according to the value indicated by the disturbance information (road surface friction coefficient TF) input from the high-order device. Here, for example, the time constant of the filter is adjusted to decrease according to the decrease in the road surface friction coefficient TF.

The first filter processor 21 reduces the time delay of the torque response to the torque command by performing the filtering processing with the time constant adjusted as described above on the input high-order torque command value Tm*.

That is, the first filter processor 21 performs feedforward processing based on the high-order torque command value. This enables feedforward calculation based on the high-order torque command value (target torque command value) to be described later.

The second filter processor 22 is a high-pass filter (HPF) or a band-pass filter (BPF) having a characteristic expressed by following Equation (2) or (3). Also in Equations (2) and (3), s is a Laplace operator and T is a time constant. Further, the time constant T is a function of the road surface friction coefficient TF (T=f(TF)).

$$[ Equation 2 ]$$

$$G 2 = \frac{{T}_{{2}^{S}}}{1 + {T}_{1} s} \qquad ( 2 )$$

$$[ Equation 3 ]$$

$$G 3 = \frac{{T}_{2} s}{( 1 + {T}_{1} s ) ( 1 + {T}_{3} s )} \qquad ( 3 )$$

The second filter processor 22 performs filtering processing on the motor rotation speed of the electric motor 15. Also in the second filter processor 22, the time constant changer 25 adjusts the time constant of the filter according to the value of the disturbance information (road surface friction coefficient TF) input from the high-order device. For example, the time constant of the filter is adjusted to decrease according to the decrease in the road surface friction coefficient TF.

The second filter processor 22 reduces the time delay of the torque response to the torque command by performing the filtering processing with the time constant adjusted as described above on the input motor rotation speed.

As illustrated in FIG. 1, the second filter processor 22 performs feedback processing based on the motor rotation speed. Accordingly, it is possible to calculate feedback torque based on a motor rotation angular velocity (motor rotation speed) to be described later.

As described above, in a feedforward control system by the first filter processor 21, the damping control device 3 performs the filtering processing with the time constant controlled on the notch filter or the low-pass filter having a large time delay. The feedforward control can attenuate the vibration associated with disturbance assumed in advance.

On the other hand, a band-pass filter or a high-pass filter with a small time delay is used for a feedback control system (a control system that performs filtering processing on a motor rotation angular velocity) by the second filter processor 22. The feedback control can attenuate the vibration accompanying actual disturbance.

A filtering processing result by the first filter processor 21 and a filtering processing result by the second filter processor 22 are added by an adder 23. An addition result in the adder 23 is input to a current controller 27 as a torque command value Tm.

The current controller 27 calculates the current control signal of the electric motor 15 based on the input torque command value Tm, and outputs the calculation result to the PWM signal generation unit 11.

The notch filter, the low-pass filter (LPF), the high-pass filter (HPF), and the band-pass filter (BPF) described above are digital filters. The time constant changers 24 and 25 function as filter time constant changers for changing the time constants of these digital filters, whereby the filtering processing described above is performed in the first filter processor 21 and the second filter processor 22.

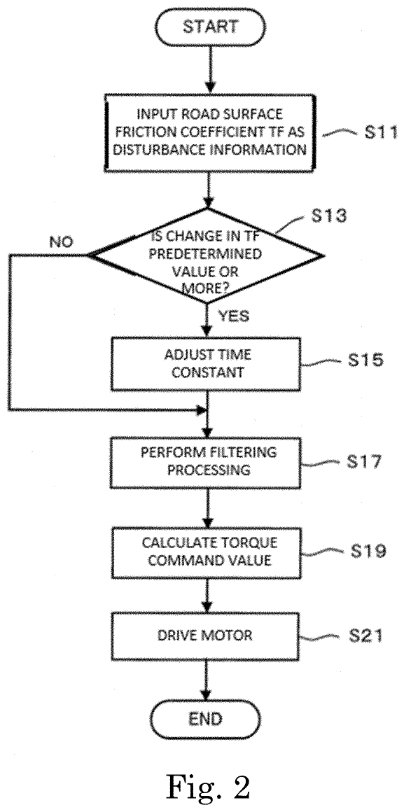

FIG. 2 is a flowchart illustrating a time constant adjustment processing procedure and a filtering processing procedure in the filter processor of the damping control device according to this example embodiment.

As described above, the damping control device receives the road surface friction coefficient TF and adjusts the time constant of the filter. The road surface friction coefficient TF is a ratio between a friction force acting on a contact face between a wheel of the vehicle and a road surface and a pressure acting perpendicularly on the contact face, and a proportional constant at this time is referred to as a friction coefficient (μ).

In general, μ of a dry asphalt paved road (dry road surface) is around 0.8, μ of a road surface wetted with water is 0.6 to 0.4, μ of a snowy road is 0.5 to 0.2, and μ of a frozen road is 0.2 to 0.1. Here, when a weight of 1 kg is pulled with a force of 1 kg, the friction coefficient is 1.

Incidentally, in the case of a snowy road, the friction coefficient can be further subdivided depending on whether the road is a simple snowy road or a pressed snow road. However, these are not distinguished here since these are not a factor that causes a large change in the friction coefficient.

In the damping control device 3 according to this example embodiment, the road surface friction coefficient TF as the disturbance information is input from the vehicle side in step S11 of FIG. 2. In subsequent step S13, it is determined whether or not the degree of change in the value of the friction coefficient TF is a predetermined value or more.

For example, it is assumed that the friction coefficient (μ) greatly decreases by about 0.8 when the traveling vehicle moves from an asphalt road to a frozen road. Here, for convenience, a case where the friction coefficient is large as in traveling on an asphalt road is referred to as “TF large”, and a case where the friction coefficient is small as in traveling on a frozen road is referred to as “TF small”.

Therefore, in a case where there is a change from “TF large” to “TF small” as described above, the road surface friction coefficient is greatly reduced. In this case, in the vehicle, the high-order torque command value from the high-order device to the motor control device shows a predetermined change. That is, in a case where no countermeasure is taken although the high-order torque command value also changes due to the change in the friction coefficient, the torque command signal is also delayed due to the delay caused by the filtering processing, and thus the slip prevention control becomes insufficient.

Therefore, in order to prevent the slip of the vehicle, the damping control device 3 performs processing of adjusting (changing) the time constant of the filter according to the degree of decrease in the road surface friction coefficient in step S15.

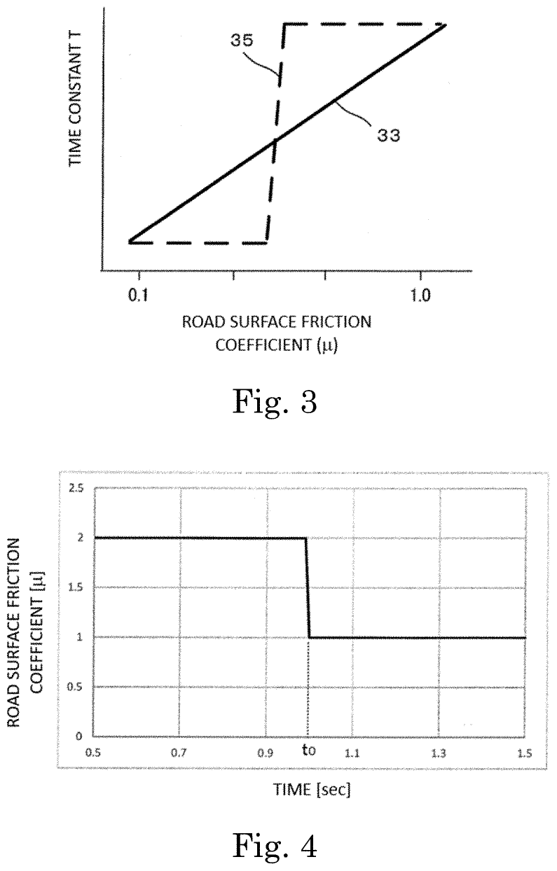

FIG. 3 illustrates an example of an adjustment characteristic of the time constant of the filter with respect to the change in the road surface friction coefficient (μ). Here, the time constant is adjusted in proportion to the change in the friction coefficient. For example, the adjustment is performed such that the time constant continuously decreases according to the decrease in the friction coefficient as in a characteristic 33 in FIG. 3. Alternatively, the adjustment is performed such that the time constant discontinuously (stepwise) decreases with respect to the decrease in the friction coefficient as in a characteristic 35.

As described above, in the first filter processor 21 and the second filter processor 22, the time delay due to the filtering processing can be arbitrarily adjusted by the time constant changed (determined) based on the disturbance information indicating the change in the road surface friction coefficient.

Incidentally, in the adjustment of the time constant, as long as the above-described proportional relationship is satisfied, adjustment may be performed using a mathematical expression, or adjustment may be performed with reference to a table. In addition, since the adjustment is the time constant adjustment of the filter for slip prevention, the characteristic may be changed such that the time constant is intensively adjusted in the low friction coefficient portion of the characteristic diagram of FIG. 3.

In a case where the time constant adjustment of the filter is completed as described above, in step S17, the filtering processing in the first filter processor 21 and the filtering processing in the second filter processor 22 are performed based on the adjusted time constant.

In step S19, the damping control device 3 calculates a torque command value Tm based on the filtering processing of step S17 (that is, by adding the filtering processing result of the first filter processor 21 and the filtering processing result of the second filter processor 22 together).

In subsequent step S21, the current controller 27 calculates the current control signal of the electric motor based on the torque command value Tm calculated in step S19. The inverter is controlled by the PWM signal generated based on the calculation result to drive the electric motor 15.

In this way, by constantly monitoring the road surface condition, adjusting the time constant of the filter based on the change in the road surface friction coefficient, and performing the filtering processing without any time delay on the change in the high-order torque command value in the situation where the vehicle slips, it is possible to perform an appropriate slip prevention control, and at the same time, it is possible to enhance the traveling safety of the vehicle.

In step S13 described above, in a case where the change in the friction coefficient is not from “TF large” to “TF small” or a case where the friction coefficient TF is not changed, it is determined that no slip is assumed to occur, and the process proceeds to the filtering processing in step S17 without the time constant adjustment.

Next, the effects of the time constant adjustment and the filtering processing in the damping control device according to this example embodiment will be described. The following examples are simulation results regarding the effects of the time constant adjustment and filtering processing.

FIG. 4 illustrates a change in the road surface friction coefficient (an example in which the friction coefficient decreases) for checking the effect of the time constant adjustment. Here, the road surface friction coefficient was decreased from 2 to 1 at time to (around 1 second).

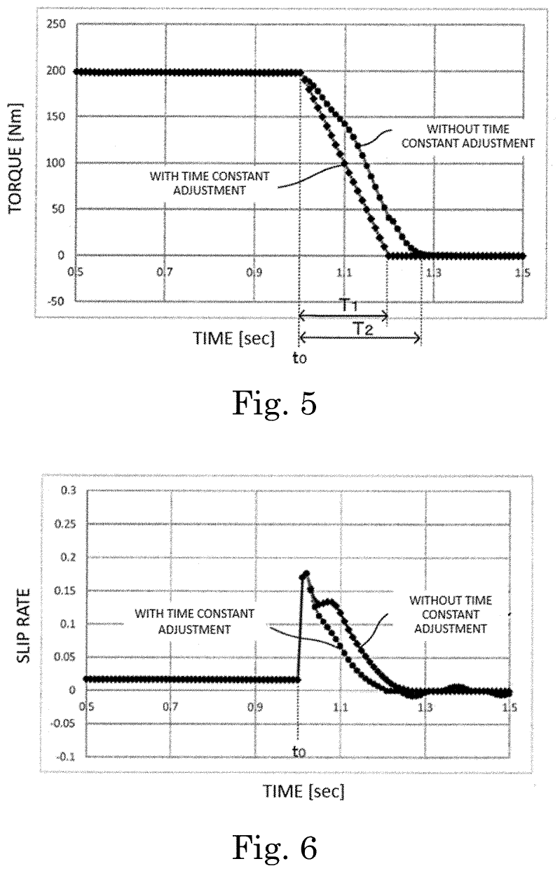

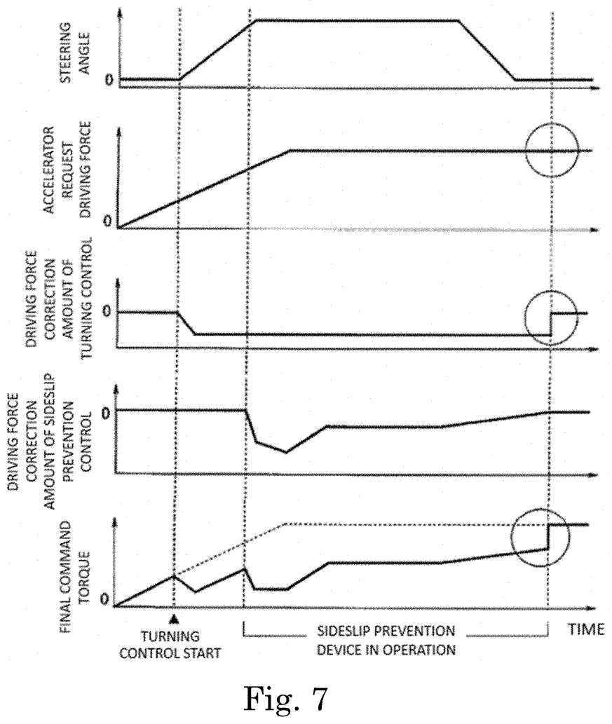

FIG. 5 is a simulation result of the time delay of the torque response (a time change of the damping torque) with respect to the presence or absence of the time constant adjustment of the filter described above. From the simulation result illustrated in FIG. 5, it can be seen that the time delay (T₁) of the torque response to the torque command when the time constant adjustment of the filter is performed is smaller than the time delay (T₂) of the torque response when the time constant adjustment is not performed.

From this, it is found that the time delay of the torque response to the torque command can be reduced by adjusting the time constant of the filter to be small according to the change in the road surface friction coefficient.

FIG. 6 illustrates a simulation result of the slip rate of the vehicle with respect to the presence or absence of the time constant adjustment of the filter. As can be seen from FIG. 6, in a case where the time constant is adjusted to be small as compared with the case without the time constant adjustment, the slip rate at the time of 1 sec to 1.3 sec is small. That is, by adjusting the filter time constant to be small according to the change in the road surface friction coefficient, it is possible to perform the slip prevention control based on a decrease in the slip rate.

As described above, the damping control device according to this example embodiment performs the process of adjusting the time constant of the filter based on the disturbance information indicating the road surface friction coefficient obtained from the vehicle side (high-order device), thereby reducing the time delay (the delay of the torque response with respect to the change in the high-order torque command value) of the filtering processing in the filter processor and enabling an effective damping control such as slip prevention.

Since the time delay of the filtering processing can be adjusted by the time constant adjustment of the filter according to the road surface condition during traveling of the vehicle, such as a large change in the road surface friction coefficient, it is possible to perform an effective damping control before the occurrence of slip, and it is possible to improve the safety of the vehicle equipped with the damping control device.

The feedforward control system and the feedback control system are provided, and the delay element of these control systems is reduced by the time constant adjustment of the filter, so that an ideal response (with improved followability for slip prevention) can be obtained with respect to any of the torque command value, the disturbance, and the like.

The present disclosure is not limited to the above-described example embodiment, and various modifications are possible.

In the damping control device according to the above-described example embodiment, a predetermined filter control according to the change in the high-order torque command value is performed using the road surface friction coefficient during traveling of the vehicle as the disturbance information. However, the filter control may be performed based on vehicle information such as the speed of the vehicle and the rotation speed of the wheel of the vehicle.

Accordingly, the filtering processing can be performed without any time delay with respect to the wheel idling prevention (traction control) based on the high-order torque command value and the torque control by the sideslip prevention control of the vehicle. For example, an effective damping control can be performed after the occurrence of slip.

The time constant changers 24 and 25 of the first filter processor 21 and the second filter processor 22 may change the time constant of the filtering processing according to (1) the disturbance information, (2) the vehicle information, or (3) the disturbance information and the vehicle information, and perform the filtering processing based on the changed time constant.

In this way, the time constant obtained by changing the time delay caused by the filtering processing based on the disturbance information or the vehicle information can be arbitrarily adjusted. Further, in a case where both the disturbance information and the vehicle information are used as in the above (3), for example, the filtering processing in consideration of the state of the road surface and the state of the vehicle can be performed. That is, it is possible to adjust the time delay of the filtering processing corresponding to the change in the disturbance information (for example, a road surface friction coefficient) or the change in the vehicle information (for example, a vehicle speed).

In the damping control device according to the above-described example embodiment, the disturbance information obtained from the vehicle is input to both the first filter processor 21 and the second filter processor 22, but the present disclosure is not limited to this configuration. For example, among the first filter processor 21 and the second filter processor 22, the first filter processor 21 including a notch filter or a low-pass filter having a large time delay is configured to always perform a filter control (time constant adjustment), so that it is possible to reliably perform a damping control with improved torque response delay.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-16. (canceled)

17. A damping control device which suppresses or minimizes vibration of a vehicle, the damping control device comprising:
an angular velocity detector to detect an angular velocity of a driving motor of the vehicle;
a first filter processor to perform filtering processing on a high-order torque command value transmitted from a high-order device;
a second filter processor to perform filtering processing on the angular velocity detected by the angular velocity detector; and
a calculator to calculate a driving torque command value to drive the motor based on a filtering processing result by the first filter processor and a filtering processing result by the second filter processor; wherein
a predetermined filter control according to a change in the high-order torque command value is performed by inputting predetermined information obtained from the vehicle to the first filter processor, or the first filter processor and the second filter processor.

18. The damping control device according to claim 17, wherein the predetermined information is disturbance information or vehicle information.

19. The damping control device according to claim 18, wherein each of the first filter processor and the second filter processor includes a time constant changer to change a time constant of the filtering processing according to the disturbance information or the vehicle information, or the disturbance information and the vehicle information, and perform filtering processing based on the changed time constant.

20. The damping control device according to claim 18, wherein the disturbance information is a road surface friction coefficient when the vehicle travels.

21. The damping control device according to claim 20, wherein when a change is made from a road surface having the road surface friction coefficient higher than a predetermined value to a road surface having the road surface friction coefficient lower than the predetermined value, the first filter processor and the second filter processor perform filtering processing based on the time constant changed by the time constant changer in proportion to the change.

22. The damping control device according to claim 20, wherein the road surface friction coefficient is detected by a road surface friction detector in the vehicle.

23. The damping control device according to claim 18, wherein the vehicle information includes at least a speed of the vehicle and a rotation speed of a wheel of the vehicle.

24. The damping control device according to claim 17, wherein the first filter processor performs feedforward processing based on the high-order torque command value, and the second filter processor performs feedback processing based on the angular velocity.

25. The damping control device according to claim 24, wherein the first filter processor is a notch filter or a low-pass filter, and the second filter processor is a band-pass filter or a high-pass filter.

26. A vehicle equipped with the damping control device according to claim 17.

27. A damping control method comprising:
detecting an angular velocity of a driving motor of the vehicle;
first filtering processing on a high-order torque command value transmitted from a high-order device;
second filtering processing on the detected angular velocity; and
calculating a driving torque command value to drive the motor based on a filtering processing result obtained by the first filtering processing and a filtering processing result obtained by the second filtering processing; wherein
in the first filtering processing, or in the first filtering processing and the second filtering processing, a predetermined filter control according to a change in the high-order torque command value is performed by inputting disturbance information obtained from the vehicle or vehicle information, or the disturbance information and the vehicle information.

28. The damping control method according to claim 27, wherein in each of the first filtering processing and the second filtering processing, a time constant of filtering processing is changed according to the disturbance information or the vehicle information, or the disturbance information and the vehicle information, and the filtering processing based on the changed time constant is performed.

29. The damping control method according to claim 27, wherein the disturbance information is a road surface friction coefficient when the vehicle travels, and the vehicle information includes at least a speed of the vehicle and a rotation speed of a wheel of the vehicle.

30. The damping control method according to claim 29, wherein in the first filtering processing and the second filtering processing step, when a change is made from a road surface having the road surface friction coefficient higher than a predetermined value to a road surface having the road surface friction coefficient lower than the predetermined value, filtering processing based on the changed time constant is performed in proportion to the change.

31. The damping control method according to claim 27, wherein in the first filtering processing, feedforward processing based on the high-order torque command value is performed, and in the second filtering processing, feedback processing based on the angular velocity is performed.

32. The damping control method according to claim 31, wherein in the first filtering processing, filtering processing is performed using a digital notch filter or a digital low-pass filter, and in the second filtering processing, filtering processing is performed using a digital band-pass filter or a digital high-pass filter.
